(19) United States
(12) Patent Application Publication
(10) Pub. No.: US 2005/0072861 A1
(43) Pub. Date: Apr. 7, 2005

(54) Dispensing head and fluid product dispenser comprising same

(76) Inventor: Ludovic Petit, Vitot (FR)

Correspondence Address: SUGHRUE MION, PLLC, 2100 PENNSYLVANIA AVENUE, N.W., SUITE 800, WASHINGTON, DC, 20037, US

(21) Appl. No.: 10/495,531

(22) PCT Filed: Nov. 13, 2002
(86) PCT No.: PCT/FR02/03871

(30) Foreign Application Priority Data
Nov. 14, 2001 (FR) 01/14722

(51) Int. Cl. B05B 7/10

(52) U.S. Cl. 239/399

(57) ABSTRACT

A dispenser head for a fluid dispenser, the head comprising a body (1) defining a fluid expulsion channel (2) terminated by a dispenser orifice (3), a rigid insert (4) being disposed in said expulsion channel (2), said dispenser head further comprising a shutter element (5) disposed in said expulsion channel (2), said shutter element (5) being displaceable between a closed position of the expulsion channel (2) and an open position of the expulsion channel (2), said shutter element (5) being urged at rest towards its closed position, being automatically displaced towards its open position while the fluid is being dispensed, and returning automatically to its closed position once the fluid has been dispensed, said shutter element (5) being formed integrally as a single piece with said rigid insert (4), so that said rigid insert (4) is displaceable in said expulsion channel (2) between a rest position, corresponding to the closed position of the shutter element (5), and an actuated position, corresponding to the open position of the shutter element (5).

The present invention relates to a dispenser head for a fluid dispenser, and more particularly to a dispenser head incorporating a shutter for closing the dispenser orifice. The present invention also relates to a fluid dispenser including such a dispenser head.

Shutters for fluid dispenser orifices are well known in the prior art. Several types exist. A first shutter family comprises those which are urged resiliently to their closed position, and which are deformed or displaced by the pressure of the fluid during dispensing, so as to open the dispenser orifice. Such devices can either include shutters made of deformable material, or shutters made in the form of a piston sliding in the expulsion channel away from the dispenser orifice, under the effect of the pressure exerted by the fluid. Document U.S. Pat. No. 5,806,762 discloses a deformable shutter surrounding a rigid insert, said shutter having a closure function that is directly linked to the pressure exerted by the fluid within the device. Another shutter family comprises shutters that are mechanically deformed by a portion of the dispenser head while the device is being actuated so as to dispense a measured quantity or “dose” of fluid. In that case the shutter is opened independently of the pressure exerted by the fluid. Document EP 0 867 228 describes an outlet valve presenting neither an insert nor a shutter at the expulsion duct of the dispenser head downstream from said valve.

Although they function correctly, such shutters present the drawback of being relatively complicated to manufacture and to assemble, and they are therefore expensive. In general, the dispenser head needs to be modified to enable the shutter to be fitted thereto, thereby also implying an increase in the manufacturing cost of the fluid dispenser device. In addition, when the dispenser head incorporates a spray profile, the presence of the shutter generally spoils the shape of said spray profile, which is prejudicial to the quality of the spray while the fluid is being expelled.

Document GB-17793 discloses a screwable insert for modifying the volume of a swirl chamber. The insert can serve as a shutter, but the user must manually displace said insert into and out of its closed position by screwing.

An object of the present invention is to provide a fluid dispenser head which does not present the above mentioned drawbacks.

Another object of the present invention is to provide a dispenser head which is simple to manufacture and to assemble, and which does not need to be modified.

Another object of the present invention is to provide a fluid dispenser head in which the shape of the spray profile at the dispenser orifice is not modified during expulsion of the fluid, thereby guaranteeing a spray of optimum quality.

Another object of the present invention is to provide a fluid dispenser including such a dispenser head.

The present invention therefore provides a dispenser head for a fluid dispenser, the head comprising a body defining a fluid expulsion channel terminated by a dispenser orifice, a rigid insert being disposed in said expulsion channel, said dispenser head further comprising a shutter element disposed in said expulsion channel, said shutter element being displaceable between a closed position of the expulsion channel and an open position of the expulsion channel, said shutter element being urged at rest towards its closed position, being automatically displaced towards its open position while the fluid is being dispensed, and returning automatically to its closed position once the fluid has been dispensed, said shutter element being formed integrally as a single piece with said rigid insert, so that said rigid insert is displaceable in said expulsion channel between a rest position, corresponding to the closed position of the shutter element, and an actuated position, corresponding to the open position of the shutter element.

Said shutter element is advantageously formed by the downstream end of said rigid insert in the flow direction of the fluid.

A hollow sleeve is advantageously statically disposed in said expulsion channel, said downstream end of said rigid insert sliding, preferably in sealed manner, in said sleeve, and a passage for the fluid being provided between the outside wall of said sleeve and the inside wall of the expulsion channel.

In the rest position of said rigid insert, the downstream end of said rigid insert advantageously extends beyond said fixed hollow sleeve and co-operates in sealed manner with said dispenser orifice.

A spray profile is advantageously defined between the front wall of the expulsion channel and said fixed hollow sleeve.

The present invention also provides a fluid dispenser device including a dispenser head as defined above.

The device is advantageously provided with a pump including a piston for dispensing the fluid, and an outlet valve, said rigid insert forming, or being secured to, said outlet valve of said pump, said rigid insert being displaced towards its actuated position while the fluid is being expelled, and being automatically returned to its rest position once the fluid has been expelled.

Said pump advantageously includes a hollow rod defining said expulsion channel, said hollow rod incorporating firstly the dispenser orifice, and secondly the piston of the pump.

Other advantages and characteristics of the invention appear more clearly from the following detailed description, made with reference to the accompanying drawings, and given by way of non-limiting examples, in which:

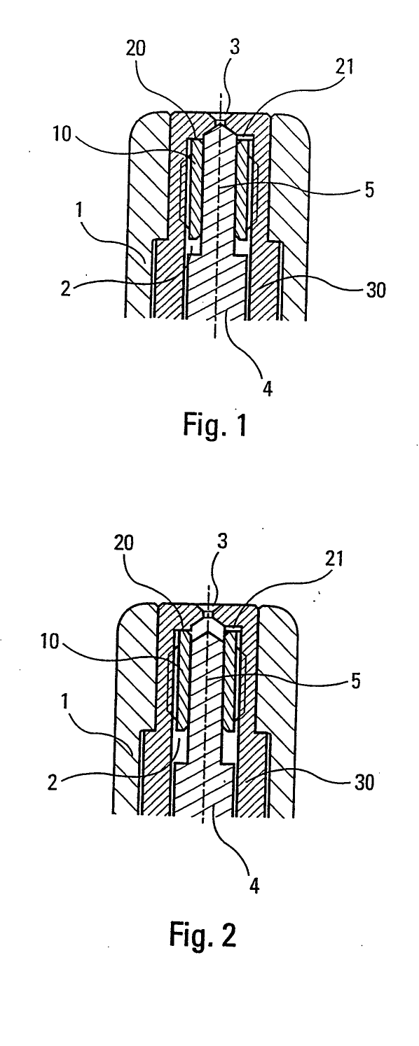

FIG. 1 is a diagrammatic cross-section view of a portion of a dispenser head constituting an advantageous embodiment of the invention, and shown in the closed position;

FIG. 2 is a view similar to the view in FIG. 1, but shown in the dispensing position; and

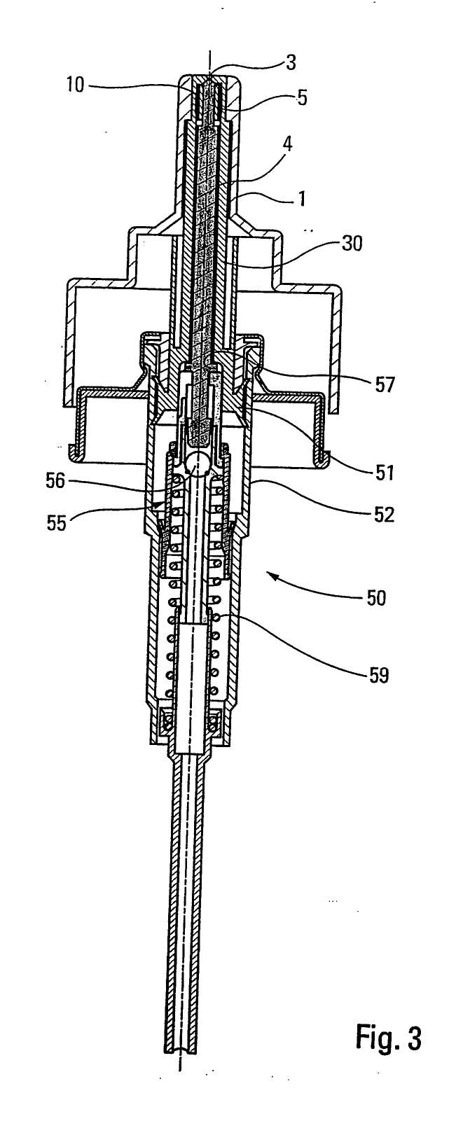

FIG. 3 is a diagrammatic cross-section view of a fluid dispenser constituting an advantageous embodiment of the invention.

The present invention relates to a dispenser head provided with a shutter. FIGS. 1 and 2 show the end portion of a nasal dispenser-head, but the present invention can also be adapted very well to other types of dispenser head.

With reference to FIGS. 1 and 2, the dispenser head comprises a body 1 defining an expulsion channel 2 which is terminated by a dispenser orifice 3. A rigid insert 4 is disposed in the expulsion channel 2 enabling the dead volume of the expulsion channel to be limited, and thereby enabling a narrow passage to be defined for the fluid, making it easier to spray said fluid through the dispenser orifice. The dispenser head advantageously includes a spray profile 21, preferably provided at the front end wall 20 of the expulsion channel 2, the dispenser orifice 3 thus being situated at the center of said spray profile 21. Preferably, and in known manner, the spray profile can include swirl channels which are connected to a swirl chamber that is disposed directly upstream from the dispenser orifice 3.

In the invention, the rigid insert 4 is disposed in movable manner in the expulsion channel 2, between a rest position shown in FIG. 1 and an actuated position shown in FIG. 2. A portion of said rigid insert, preferably its downstream end 5 in the flow direction of the fluid, forms a shutter element for closing the dispenser orifice. The shutter element is therefore displaced together with said insert 4 between a closed position (FIG. 1) corresponding to the rest position of the insert 4, and an open position (FIG. 2) corresponding to the actuated position of the insert 4. The shutter-forming insert 4 is urged towards its closed position, and, while the fluid is being dispensed, is automatically displaced towards its open position, before automatically returning once again to its initial position, i.e. its closed position.

Preferably, a hollow element, such as a hollow sleeve 10, is fixed in the expulsion channel 2, in the vicinity of the front wall 20 of said expulsion channel 2. Advantageously, the spray profile 21 can be provided between said fixed sleeve 10 and said front wall 20, in one or other of said elements, or even simultaneously in both if desired. The downstream end 5 of the rigid insert 4 slides, preferably in sealed manner, inside said fixed hollow sleeve 10, whereas the fluid flows outside said sleeve 10, between its outside wall and the inside wall of the expulsion channel 2.

In the embodiment shown, the downstream end 5 of the insert 4 has a diameter that is less than the diameter of the insert 4 as a whole, so as to reduce dead volume to make it as small as possible. Thus, as shown in the figures, the rigid insert 4 fills substantially all of the volume of the expulsion channel 2, leaving only a narrow passage for the fluid, and the presence of the hollow sleeve 10 at the downstream end of the expulsion channel 2 implies that the downstream end portion 5 of the insert 4 is of small diameter, in order to pass through said hollow sleeve 10.

As described above, the front wall 20 of the expulsion channel 2 can advantageously include a spray profile 21. In this case, the embodiment shown in the figures presents a major advantage in that, in the actuated position, the spray profile 21 presents an unmodified shape, since it is defined between the fixed sleeve 10 and the end wall of the expulsion channel 2. This is very different from present-day shutters made of deformable material, which are generally resiliently deformed towards their open position, so that the spray profile is necessarily modified during expulsion, which can spoil the quality of the spray. As can be clearly seen in the figures, this drawback is not reproduced by the present invention.

As also shown in the figures, the downstream end 5 of the rigid insert 4 advantageously extends beyond the hollow sleeve 10, and comes to co-operate in sealed manner with the dispenser orifice 3 in the rest position of said rigid insert 4. This embodiment ensures that the dispenser orifice 3 is itself closed. Thus, the risk of contaminating the fluid remaining inside the swirl chamber or inside the spray profile after expulsion of the dose is avoided.

The dispenser head of the present invention can be applied to any type of fluid dispenser device. FIG. 3 shows an advantageous embodiment of a dispenser including a dispenser head as described above. It comprises a reservoir (not shown) containing the fluid to be dispensed, and on which reservoir there is mounted a dispenser member, such as a pump 50, which comprises a piston 51 sliding in a pump body 52, the actuation of said piston 51 enabling the fluid contained in the reservoir to be dispensed selectively. A pump chamber 55 is defined between an inlet valve 56, which connects the pump chamber 55 to the reservoir, and an outlet valve 57, which connects the pump chamber 55 to the expulsion channel 2 of said dispenser head. The rigid insert 4 is advantageously secured to said outlet valve 57 so that it is displaced from its rest position to its actuated position when the outlet valve 57 is opened, enabling the fluid to be expelled from said pump chamber 55. In particular, said rigid insert 4 itself forms the outlet valve 57 of the pump 50, and said rigid insert 4 is displaced from its rest position to its actuated position at the end of the actuating stroke of the piston 51 of the pump, guaranteeing that the expulsion channel 2 and the dispenser orifice 3 are opened at the precise moment when the fluid contained in the pump chamber 55 is expelled. At the end of fluid expulsion, the outlet valve 57 is closed by the return spring 59 of the pump 50 returning the insert 4 to its rest position, i.e. the closed position of the shutter (cf. FIG. 1). The shutter is therefore opened and closed mechanically by opening and closing the outlet valve 57 of the pump 50.

The expulsion channel 2 is advantageously formed by a hollow rod 30 which is securely connected to the piston 51 of the pump, or is even formed integrally therewith, as shown in the figures. The hollow rod 30 therefore also incorporates the dispenser orifice 3. Since the hollow rod 30 cannot be removed, this embodiment foils any attempt to remove the head, which would risk contaminating the fluid. In this embodiment, the body 1 acts solely as an element for actuating the pump 50. It can be removable and can be made in any desired shape, and, in particular, it can be adapted in terms of its shape or its decoration to the fluid to be dispensed.

The present invention is described above with reference to an advantageous embodiment thereof, but naturally, various modifications can be applied thereto without going beyond the ambit of the present invention as defined by the accompanying claims.

1. A dispenser head for a fluid dispenser, the head comprising a body (1) defining a fluid expulsion channel (2) terminated by a dispenser orifice (3), a rigid insert (4) being disposed in said expulsion channel (2), said dispenser head being characterized in that it further comprises a shutter element (5) disposed in said expulsion channel (2), said shutter element (5) being displaceable between a closed position of the expulsion channel (2) and an open position of the expulsion channel (2), said shutter element (5) being urged at rest towards its closed position, being automatically displaced towards its open position while the fluid is being dispensed and returning automatically to its closed position once the fluid has been dispensed, said shutter element (5) being formed integrally as a single piece with said rigid insert (4), so that said rigid insert (4) is displaceable in said expulsion channel (2) between a rest position, corresponding to the closed position of the shutter element (5), and an actuated position, corresponding to the open position of the shutter element (5).

2. A dispenser head according to claim 1, in which said shutter element is formed by the downstream end (5) of said rigid insert (4) in the flow direction of the fluid.

3. A dispenser head according to claim 2, in which a hollow sleeve (10) is statically disposed in said expulsion channel (2), said downstream end (5) of said rigid insert (4) sliding, preferably in sealed manner, in said sleeve (10), and a passage for the fluid being provided between the outside wall of said sleeve (10) and the inside wall of the expulsion channel (2).

4. A dispenser head according to claim 3, in which, in the rest position of said rigid insert (4), the downstream end (5) of said rigid insert (4) extends beyond said fixed hollow sleeve (10) and co-operates in sealed manner with said dispenser orifice (3).

5. A dispenser head according to claim 3, in which a spray profile (21) is defined between the front wall (20) of the expulsion channel (2) and said fixed hollow sleeve (10).

6. A fluid dispenser device, characterized in that it includes a dispenser head according to claim 1.

7. A device according to claim 6, provided with a pump (50) including a piston (51) for dispensing the fluid, and an outlet valve (57), said rigid insert (4) forming, or being secured to, said outlet valve (57) of said pump (50), said rigid insert (4) being displaced towards its actuated position while the fluid is being expelled, and being automatically returned to its rest position once the fluid has been expelled.

8. A device according to claim 7, in which said pump (50) includes a hollow rod (30) defining said expulsion channel (2), said hollow rod (30) incorporating firstly the dispenser orifice (3), and secondly the piston (51) of the pump (50).
